(19) United States
(12) Patent Application Publication
(10) Pub. No.: US 2019/0092130 A1
(43) Pub. Date: Mar. 28, 2019

(54) REFRIGERATION CYCLE DEVICE

(71) Applicants: DENSO CORPORATION, Kariya-city, Aichi-pref. (JP); SOKEN, INC., Nishio-city, Aichi (JP)

(72) Inventors: Masato KOMURA, Nisshin-city (JP); Toru OKUMA, Kariya-city (JP); Yoshitaka AKIYAMA, Kariya-city (JP); Yusuke ITO, Kariya-city (JP)

(21) Appl. No.: 16/086,354

(22) PCT Filed: Mar. 10, 2017
(86) PCT No.: PCT/JP2017/009770

§ 371 Date: Sep. 19, 2018

(30) Foreign Application Priority Data
Mar. 22, 2016 (JP) 2016-057495

(51) Int. Cl. B60H 1/32

(52) U.S. Cl. CPC B60H 1/3205; B60H 2001/3275; B60H 2001/3238; B60H 1/3223

(57) ABSTRACT

A refrigeration cycle device includes: a variable displacement compressor including a discharge capacity varying part to change a refrigerant discharge capacity; a controller that outputs a capacity control signal to the variable displacement compressor to change the refrigerant discharge capacity; a heat exchanger that condenses or cools refrigerant discharged from the variable displacement compressor; a decompressor that decompresses and expands refrigerant flowing out of the heat exchanger; an evaporator that evaporates refrigerant decompressed and expanded by the decompressor; and a high load determiner that determines whether the compressor is in a high load operational status based on the capacity control signal.

### CROSS REFERENCE TO RELATED APPLICATION

This application is based on Japanese Patent Application No. 2016-57495 filed on Mar. 22, 2016, the disclosure of which is incorporated herein by reference.

### TECHNICAL FIELD

The present disclosure relates to a refrigeration cycle device including a variable displacement compressor with a discharge capacity varying part to change a refrigerant discharge capacity.

### BACKGROUND ART

This kind of compressor is equipped with a shaft seal device, such as a lip seal or a mechanical seal, to prevent leak of refrigerant or lubricous oil from a housing through a clearance between the housing and a driving shaft. Moreover, such a compressor is equipped also with many slide components, such as a thrust bearing and a radial bearing.

When the temperature of the shaft seal device or the slide component becomes high, the wear resistance or the baking properties is affected. When carbon dioxide is adopted as a refrigerant, the temperature of refrigerant discharged from the compressor becomes high, and the environmental temperature of the shaft seal device or the slide component also becomes high. For this reason, the shaft seal device and the slide component should be protected when the environmental temperature of the shaft seal device or the slide component becomes high.

Patent Literature 1 describes a high-pressure pressure sensor which detects the pressure of refrigerant in a piping that connects the exit of the compressor to the entrance of the condenser or the gas cooler. Patent Literature 1 describes that the discharge capacity is decreased to avoid a high load operating range, when the pressure detected by the high-pressure pressure sensor exceeds a predetermined threshold value.

### PRIOR ART LITERATURES

### Patent Literature

Patent Literature 1: JP 2009-209823 A

### SUMMARY OF INVENTION

In the device of Patent Literature 1, the discharge capacity is controlled to decrease when the pressure of refrigerant discharged from the compressor exceeds a predetermined threshold value. However, according to the inventors' study, it is found out that the correlation between the discharge pressure of the compressor and the temperature of the slide component is low, when carbon dioxide is used as a refrigerant in the compressor for a refrigeration cycle. This is because a control is performed to maintain the refrigerant discharge pressure uniform in many cases, for the refrigeration cycle using carbon dioxide as a refrigerant.

In the compressor of Patent Literature 1, when carbon dioxide is adopted as a refrigerant, it is difficult to accurately determine the high load operating range of the compressor.

The present disclosure aims at determining a high load operational status of a compressor with sufficient accuracy, without using a refrigerant discharge pressure.

According to an aspect of the present disclosure, a refrigeration cycle device for a vehicle includes: a variable displacement compressor including a discharge capacity varying part to change a refrigerant discharge capacity; a controller that outputs a capacity control signal to the variable displacement compressor to change the refrigerant discharge capacity; a heat exchanger that condenses or cools refrigerant discharged from the variable displacement compressor; a decompressor that decompresses and expands refrigerant flowing out of the heat exchanger; an evaporator that evaporates refrigerant decompressed and expanded by the decompressor; and a high load determiner that determines whether the compressor is in a high load operational status based on the capacity control signal.

Accordingly, the high load operational status of the compressor can be determined with sufficient accuracy, without using the refrigerant discharge pressure.

### BRIEF DESCRIPTION OF DRAWINGS

FIG. 1 is a schematic view illustrating a refrigeration cycle device for a vehicle according to a first embodiment, and an internal structure of a compressor of the refrigeration cycle device.

FIG. 2 is a sectional view illustrating a flow rate control valve in the compressor of FIG. 1.

FIG. 3 is a control block diagram of an air-conditioner for a vehicle, using the refrigeration cycle device of the first embodiment.

FIG. 4 is a flow chart illustrating a flow of an air-conditioning control in the air-conditioner, according to the first embodiment.

FIG. 5A is a graph illustrating a comparative example between an estimated value and an actual measurement value of a crankcase temperature.

FIG. 5B is a graph illustrating a comparative example between an estimated value and an actual measurement value of a shaft seal temperature.

FIG. 5C is a graph illustrating a comparative example between an estimated value and an actual measurement value of a pulley bearing temperature.

FIG. 6 is a flow chart illustrating a flow of an air-conditioning control in an air-conditioner for a vehicle, according to a second embodiment.

### DESCRIPTION OF EMBODIMENTS

Embodiments of the present disclosure will be described hereafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

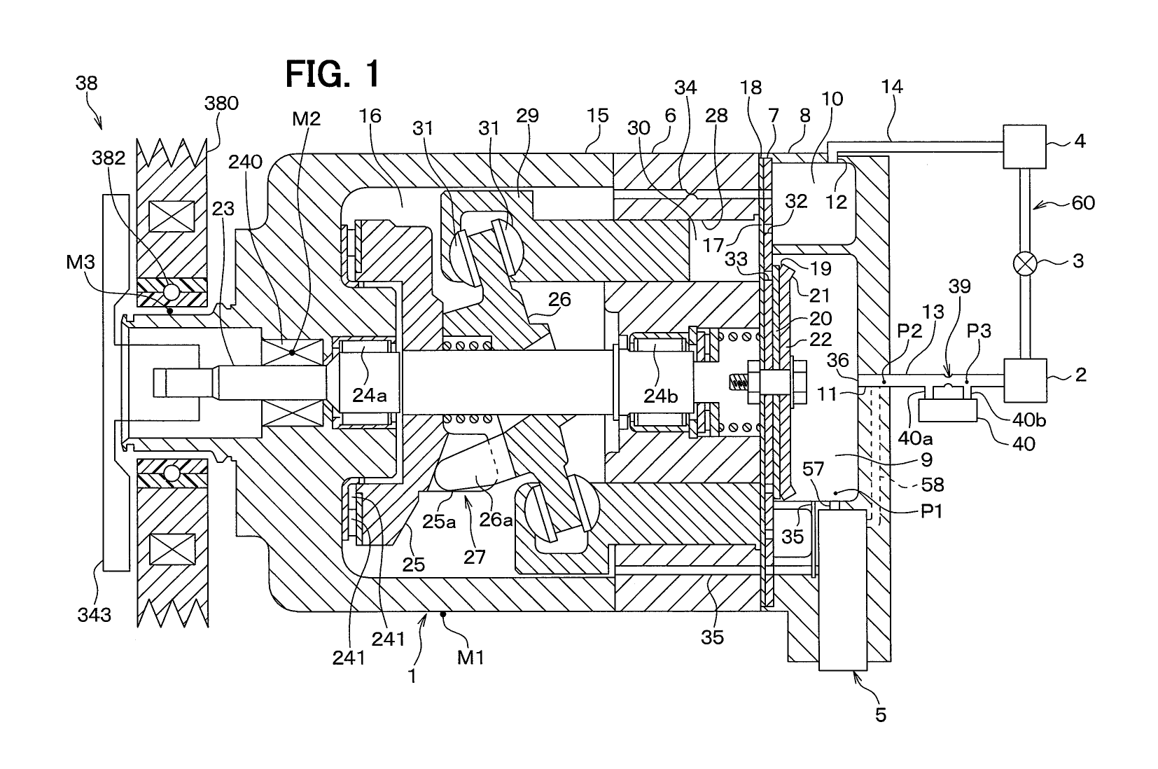

A refrigeration cycle device 60 for a vehicle according to a first embodiment is explained with reference to FIGS. 1-4 and FIGS. 5A-5C. FIG. 1 is a schematic view illustrating the refrigeration cycle device 60 and an internal structure of a compressor 1 of the refrigeration cycle device 60.

The refrigeration cycle device 60 for an air-conditioner of a vehicle includes the compressor 1, a heat exchanger 2, an expansion valve 3, and an evaporator 4, which are connected annularly. The compressor 1 draws in refrigerant, raises the pressure of the refrigerant, and discharges the refrigerant. The heat exchanger 2 condenses or cools the refrigerant discharged out of the compressor 1. The expansion valve 3 is a decompressor which decompresses and expands the refrigerant flowing out of the heat exchanger 2. The evaporator 4 evaporates the refrigerant decompressed and expanded by the expansion valve 3. The heat exchanger 2 may be a condenser or a gas cooler. In the refrigeration cycle device 60 of this embodiment, carbon dioxide is adopted as a refrigerant.

The compressor 1 has a discharge capacity varying part to change the refrigerant discharge capacity. The refrigerant discharge capacity is controlled by a flow rate control valve 5 which is a flow rate control mechanism for refrigerant. The discharge capacity varying part includes a slanting board 26 to be mentioned later, in addition to the flow rate control valve 5. A rear housing 8 is joined through a valve plate 7 to a rear end surface of a cylinder block 6 of the compressor 1. A discharge chamber 9, an intake chamber 10, a discharge passage 11 connected with the discharge chamber 9, and an intake passage 12 connected with the intake chamber 10 are defined inside the rear housing 8. The discharge passage 11 is connected with the heat exchanger 2 through a discharge pipe 13, and the intake passage 12 is connected with the evaporator 4 through an intake pipe 14.

A fixed throat part 39 for obtaining a flow difference pressure between two points and a flow rate sensor 40 as a difference pressure detector are disposed in the refrigerant passage defined by the discharge pipe 13 between the compressor 1 and the heat exchanger 2. The flow rate sensor 40 can detect the flow difference pressure (namely, PdL-PdLL) between the high-pressure refrigerant on the upstream side of the fixed throat part 39, and the low-pressure refrigerant on the downstream side of the fixed throat part 39 with sufficient accuracy. The flow difference pressure is a flow difference pressure between a second pressure monitor point P2 in the high-pressure refrigerant and a third pressure monitor point P3 in the low-pressure refrigerant. The flow difference pressure (namely, PdL-PdLL) is almost equal to a difference pressure AP (namely, PdH-PdL) between a first pressure monitor point P1 to be mentioned later and the second pressure monitor point P2.

The flow rate sensor 40 has a high-pressure passage 40a, a low-pressure passage 40b, a movable object, a coil spring, a magnet, and a position sensor, although the details of the structure are not illustrated. The high-pressure passage 40a is communicated with the discharge passage 11 including the second pressure monitor point P2 where the high-pressure refrigerant flows, at the upstream side of the fixed throat part 39. The low-pressure passage 40b is communicated with a passage including the third pressure monitor point P3 where the low-pressure refrigerant flows, at the downstream side of the fixed throat part 39. The movable object consists of a spool sliding in the high-pressure passage 40a. The coil spring biases the movable object toward the high-pressure passage 40a. The magnet is disposed at the tip part of the movable object. The position sensor is arranged to oppose the magnet, and detects the displacement of the movable object.

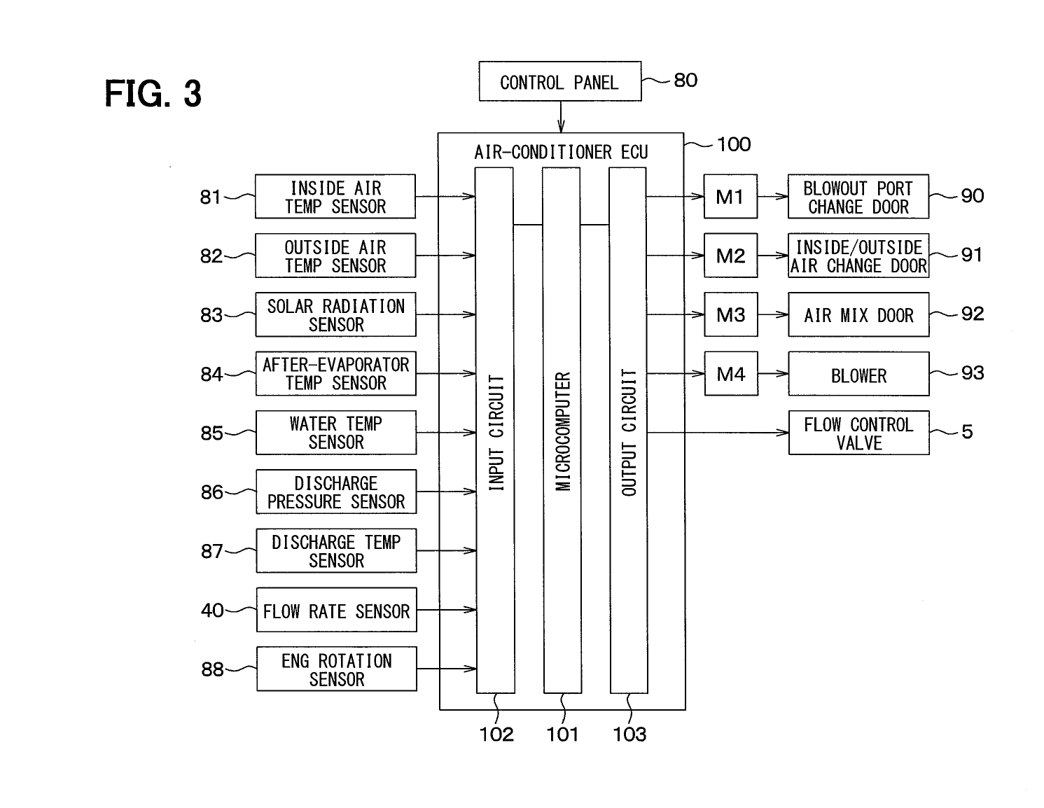

The flow rate control valve 5 is controlled by an air-conditioner ECU 100 of FIG. 3 corresponding to a controller of the air-conditioner. The flow rate control valve 5 is explained in detail later.

The compressor 1 has an electromagnetic clutch 38 which transmits the power of an unillustrated engine to a driving shaft 23. The electromagnetic clutch 38 has a pulley 380, a hub 343, and a pulley bearing 382. The pulley 380 is a driving rotor rotated by the rotation power given through unillustrated V belt from the unillustrated engine. The hub 343 has an approximately disk shape. The hub 343 rotates integrally with the driving shaft 23 of the compressor 1, and is displaced relatively in the axial direction of the driving shaft 23 of the compressor 1. The hub 343 is a driven rotor connected with the driving shaft 23 of the compressor 1. The electromagnetic clutch 38 connects or disconnects the pulley 380 and the hub 343, to intermittently transfer the rotation power from the engine to the compressor 1.

The pulley bearing 382 is interposed between the pulley 380 and a front housing 15, and supports the pulley 380 rotatably to the front housing 15.

The power supply to the electromagnetic clutch 38 is intermittently conducted by the air-conditioner ECU 100. When the electromagnetic clutch 38 is energized to connect the pulley 380 and the hub 343, the compressor 1 is in operational status. When the power supply to the electromagnetic clutch 38 is intercepted to disconnect the pulley 380 and the hub 343 from each other, the compressor 1 stops.

Next, the internal structure of the compressor 1 is explained with reference to FIG. 1. The front housing 15 is joined to the front end surface of the cylinder block 6 of the compressor 1. A crankcase 16, which is partitioned, is formed inside of the front housing 15. An intake valve formation board 18 which is united with the intake valve 17 is formed between the cylinder block 6 and the valve plate 7. A discharge valve formation board 20 which is united with the discharge valve 19, and a retainer formation board 22 which defines a retainer 21 are formed between the valve plate 7 and the rear housing 8. The cylinder block 6, the front housing 15, and the rear housing 8 are united and tightly fixed with a through bolt.

The driving shaft 23 is rotatably supported through radial bearings 24a and 24b in a shaft hole formed at the central part of the cylinder block 6 and the front housing 15. The driving shaft 23 is connected with the engine through the unillustrated V belt and the electromagnetic clutch 38, so that an operation is possible, and is rotated in response to the power supplied from the engine. A lug plate 25 which is rotatable in the crankcase 16 is integrally fixed to the driving shaft 23, and the slanting board 26 which is a cam plate is arranged in a state where the driving shaft 23 passes through the slanting board 26.

The lug plate 25 and the slanting board 26 are connected by a hinge mechanism 27. The hinge mechanism 27 includes two projections 25a projected from the lug plate 25 toward the slanting board 26, and a projection 26a projected from the slanting board 26 toward the lug plate 25. The projection 26a is arranged so that the tip side of the projection 26a is fitted between the two projections 25a. The rotational force of the lug plate 25 is transmitted to the slanting board 26 through the projections 25a and the projection 26a.

The slanting board 26 is rotatable synchronizing with the lug plate 25 and the driving shaft 23, due to the connection with the lug plate 25 by the hinge mechanism 27 and the support by the driving shaft 23. Furthermore, the slanting board 26 is able to move obliquely to the driving shaft 23, while the driving shaft 23 slides in the axial direction. Moreover, the lug plate 25 is rotatably supported through a thrust bearing 241 by the front housing 15.

A mechanical seal 240 is disposed between the driving shaft 23 and the front housing 15. The mechanical seal 240 prevents leak of refrigerant from a clearance between the front housing 15 and the driving shaft 23 to the exterior of the front housing 15.

A piston 29 is housed in each of cylinder bores 28 arranged in the circumferential direction inside the cylinder block 6, so that the piston 29 is able to reciprocate. The compression chamber 30 is formed between one end of each piston 29 and the valve plate 7, and the capacity of the compression chamber 30 is changed by the piston 29. The other end of the piston 29 is supported by a peripheral part of the slanting board 26 through a shoe 31.

When the engine power transmits to the driving shaft 23 through the V belt and the electromagnetic clutch 38, the driving shaft 23 rotates. Then, the slanting board 26 rotates through the lug plate 25 and the hinge mechanism 27, and the piston 29 moves reciprocately inside the cylinder bore 28 through the shoe 31. At the time of the intake stroke of the piston 29, refrigerant gas introduced in the intake chamber 10 from the evaporator 4 passes through the intake port 32, pushes the intake valve 17, and is drawn by the compression chamber 30. When the piston 29 shifts to a compression stroke and a discharge stroke, the refrigerant gas in the compression chamber 30 passes through the discharge port 33, pushes the discharge valve 19, and is discharged into the discharge chamber 9.

A passage 34 and a supply passage 35 are defined inside of the cylinder block 6 and the rear housing 8 respectively. The crankcase 16 and the intake chamber 10 communicate with each other through the passage 34. The discharge chamber 9 and the crankcase 16 communicate with each other through the supply passage 35. The flow rate control valve 5 is arranged inside of the rear housing 8, and is located in the middle of the supply passage 35.

When the open degree of the flow rate control valve 5 is adjusted according to a capacity control signal outputted from the air-conditioner ECU 100, the balance is controlled, between the introduction amount of the high-pressure refrigerant gas to the crankcase 16 through the supply passage 35 and the exhaust amount of the refrigerant gas from the crankcase 16 through the passage 34, and the internal pressure of the crankcases 16 is determined. When a difference between an internal pressure of the crankcases 16 and an internal pressure of the compression chamber 30, through the piston 29, is changed by the change in the internal pressure of the crankcases 16, the gradient angle of the slanting board 26 changes, and the discharge capacity of the compressor 1 is adjusted.

When the opening degree of the flow rate control valve 5 becomes small according to the capacity control signal outputted from the air-conditioner ECU 100, the internal pressure of the crankcases 16 is lowered. When the internal pressure of the crankcases 16 falls, the gradient angle of the slanting board 26 increases, and the discharge capacity of the compressor 1 increases. FIG. 1 illustrates a state with the maximum gradient angle where the slanting board 26 is restricted from moving, due to the lug plate 25.

Conversely, when the open degree of the flow rate control valve 5 becomes large according to the capacity control signal outputted from the air-conditioner ECU 100, the internal pressure of the crankcases 16 rises. When the internal pressure of the crankcases 16 rises, the gradient angle of the slanting board 26 becomes small, the stroke of the piston 29 decreases, and the discharge capacity of the compressor 1 decreases. Thus, air-conditioning for the vehicle cabin is changed to be optimal by changing the gradient angle of the slanting board 26 to adjust the discharge capacity of the compressor 1.

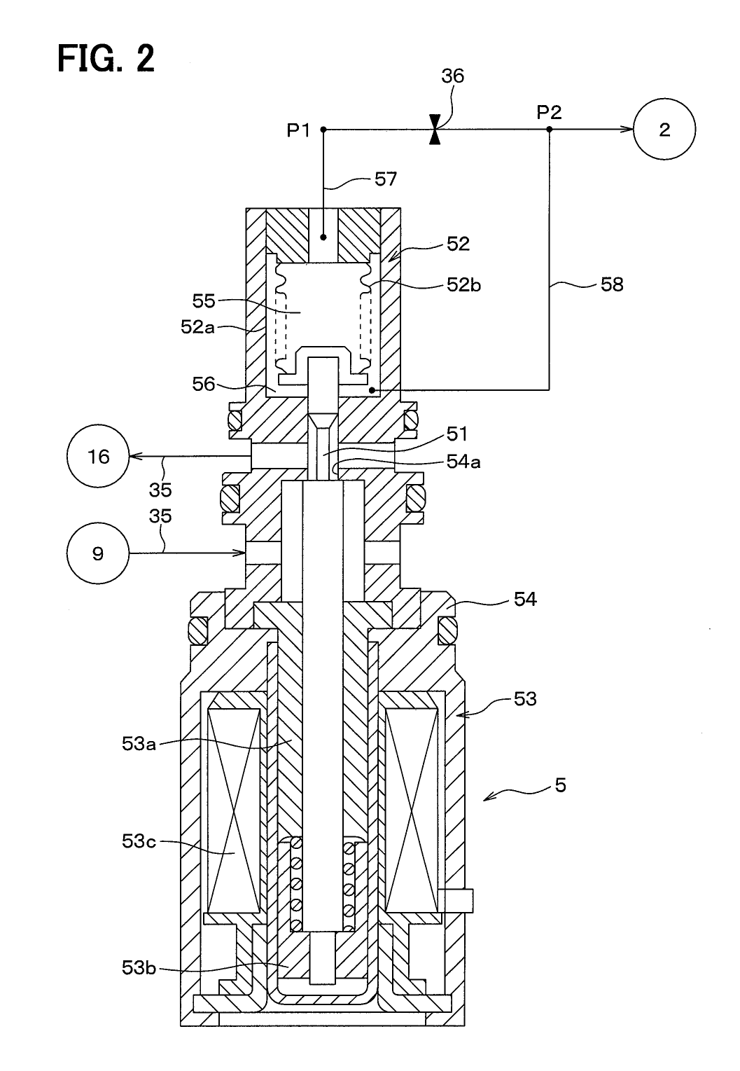

Next, the flow rate control valve 5 is explained with reference to FIG. 2. FIG. 2 is a sectional view illustrating the structure of the flow rate control valve 5. As shown in FIG. 2, the flow rate control valve 5 includes the valve object 51 which adjusts the open degree of the supply passage 35, a pressure-sensitive mechanism 52 connected with the valve object 51 so that an operation is possible, on the upper side in the drawing, and an electromagnetic actuator 53 connected with the valve object 51 so that an operation is possible, on the lower side in the drawing, which are inside of the valve housing 54. A valve hole 54a is formed in the valve housing 54 as a part of the supply passage 35. When the valve object 51 moves downward, the open degree of the valve hole 54a increases. Conversely, when the valve object 51 moves upward, the open degree of the valve hole 54a becomes small.

The pressure-sensitive mechanism 52 includes a pressure-sensitive chamber 52a formed in the upper part of the valve housing 54, and a bellows 52b which is a pressure-sensitive component housed in the pressure-sensitive chamber 52a. The pressure-sensitive chamber 52a is divided by the bellows 52b into a first pressure chamber 55 which is the interior space of the bellows 52b, and a second pressure chamber 56 which is the exterior space of the bellows 52b. The first pressure chamber 55 and the first pressure monitor point P1 communicate through a first detecting passage 57. The second pressure chamber 56 and the second pressure monitor point P2 communicate through a second detecting passage 58.

A fixed throat part 36 is located between the first pressure monitor point P1 and the second pressure monitor point P2, in the discharge passage 11, to increase the difference pressure AP (namely, PdH-PdL) between the two points P1 and P2. A pressure loss per unit length (namely, the difference pressure) becomes large, as the flow rate of refrigerant which flows through a refrigeration cycle increases. That is, the flow rate of refrigerant in a refrigeration cycle can be indirectly detected by obtaining the difference pressure between the two monitor points P1 and P2 (hereafter referred to as a difference pressure ΔP between two points). The flow rate of refrigerant can be more clearly detected when the fixed throat part 36 increases the difference pressure ΔP between two points.

Accordingly, in the pressure-sensitive mechanism 52, the pressure PdH is led to the first pressure chamber 55, and the pressure PdL is led to the second pressure chamber 56. The bellows 52b applies the thrust force, downward in the drawing, on the valve object 51, based on the difference pressure ΔPd between the pressure PdH and the pressure PdL.

The electromagnetic actuator 53 includes a fixed iron core 53a, a movable iron core 53b, and a coil 53c. The valve object 51 is connected with the movable iron core 53b so that an operation is possible. Electromagnetic force is generated between the fixed iron core 53a and the movable iron core 53b, upward in the drawing, according to the electric energy supplied to the coil 53c, and is transmitted to the valve object 51 through the movable iron core 53b.

In the flow rate control valve 5, the forces balance with the following expression F1, and the position of the valve object 51 is determined by the balance of the forces. The expression F1 is beforehand memorized by the microcomputer 101 of the air-conditioner ECU 100.

AxΔPd+BxΔPdc+Fspr=Fsol (F1)

Fsol represents the electromagnetic force, upward in the drawing, applied to the valve object 51 by the movable iron core 53b due to the power supply to the coil 53c. AxΔPd represents the thrust force, downward in the drawing, based on the difference pressure ΔPd applied to the valve object 51 by the bellows 52b (namely, difference pressure between the refrigerant at P1 and the refrigerant in P2 in FIG. 1 or FIG. 2). A is a cross-sectional area of the bellows 52b on which the difference pressure ΔPd acts. BxΔPdc represents the thrust force, downward in the drawing, based on the difference pressure ΔPdc between the discharge chamber 9 and the crankcase 16. B is a cross-sectional area of the valve object 51 on which the difference pressure ΔPdc acts. Fspr is the biasing force, downward in the drawing, based on a predetermined spring force of the bellows 52b.

Next, the control system of the air-conditioner for a vehicle which uses the refrigeration cycle device 60 is explained. FIG. 3 is a block diagram of the control system in the air-conditioner. As shown in FIG. 3, the air-conditioner for a vehicle includes an indoor air-conditioning unit, the air-conditioner ECU 100, and the control panel 80. The indoor air-conditioning unit is arranged between the engine room and the rear surface of the instrument panel in the vehicle cabin. The air-conditioner ECU 100 can automatically control each part 90-93 (namely, various doors, blower, etc.) of the indoor air-conditioning unit, and the flow rate control valve 5 which is a component of the refrigeration cycle device 60. The control panel 80 is operated by an occupant to set up a desired operation.

When a command signal transmitted from the control panel 80 is received, the air-conditioner ECU 100 performs calculations by a predetermined program, and can execute the air-conditioning operation. The air-conditioner ECU 100 includes a microcomputer 101, an input circuit 102, and an output circuit 103. Sensor signals are inputted into the input circuit 102 from the various sensors 40, 81-87, and switch signals are inputted into the input circuit 102 from various switches on the control panel 80 in front of the vehicle cabin. The output circuit 103 sends a capacity control signal to the flow rate control valve 5 while sending an output signal to each of the various actuators M1-M4.

The microcomputer 101 has a memory such as ROM (namely, memory device only for reading) and RAM (namely, memory device which can both read and write) and CPU (namely, central processing unit). The microcomputer 101 has various programs used for the operation based on the operation command transmitted from the control panel 80. The expression 1 is contained in the programs.

An air-conditioning switch, an inlet change switch, a temperature setting switch, an air amount change switch, an outlet change switch are prepared on the control panel 80. The air-conditioning switch is a switch for starting or stopping the compressor 1. The inlet change switch is a switch for changing the inlet mode. The temperature setting switch is a switch for setting the temperature in the vehicle cabin. The air amount change switch is a switch for changing the amount of air sent to the vehicle cabin by the blower 93. The outlet change switch is a switch for changing the outlet mode.

Various sensors comprise an inside air temperature sensor 81, an outside air temperature sensor 82, a solar radiation sensor 83, an after-evaporator temperature sensor 84, a water temperature sensor 85, a discharge pressure sensor 86, a discharge temperature sensor 87, a flow rate sensor 40, and an engine rotation speed sensor 88.

The inside air temperature sensor 81 detects the air temperature in the vehicle cabin, and the outside air temperature sensor 82 detects temperature of air outside the vehicle cabin. The solar radiation sensor 83 detects the solar amount irradiated into the vehicle cabin, and the after-evaporator temperature sensor 84 detects the fin temperature of the heat exchange core part in the evaporator 4. The water temperature sensor 85 detects the cooling water temperature to the heater which heats air inside the indoor air-conditioning unit. The discharge pressure sensor 86 detects the discharge-side refrigerant pressure Pd discharged from the compressor 1. The discharge temperature sensor 87 detects the discharge-side refrigerant temperature Td discharged from the compressor 1. The flow rate sensor 40 detects the flow rate of refrigerant flowing in the refrigerant passage formed by the discharge pipe 13, which connects the compressor 1 and the heat exchangers 2, by detecting the difference pressure between the upstream refrigerant and the downstream refrigerant. The engine rotation speed sensor 88 detects the engine rotation speed Nc. The detection signals of the sensors are inputted into the air-conditioner ECU 100.

The after-evaporator temperature sensor 84 is an example of an evaporator temperature detector which detects the exit-side temperature of the evaporator 4. The after-evaporator temperature sensor 84 is a fin temperature sensor inserted between the fins of the heat exchange core part of the evaporator 4. Alternatively, as other examples of the evaporator temperature detector, an after-evaporator air temperature sensor may be used, which detects the air temperature immediately after passing the heat exchange core part of the evaporator 4.

The microcomputer 101 includes a memory, such as ROM and RAM, and CPU, and has the various programs used for the calculation based on the operation command transmitted from the control panel 80. The signal outputted from the microcomputer 101 is D/A converted and amplified by the output circuit 103, and outputted to the various actuators M1, M2, M3, M4 and the flow rate control valve 5 as drive signal. The actuators M1, M2, M3, M4 drive the blow-out port change door 90, the inside/outside air change door 91, the air mix door 92, and the blower 93 respectively.

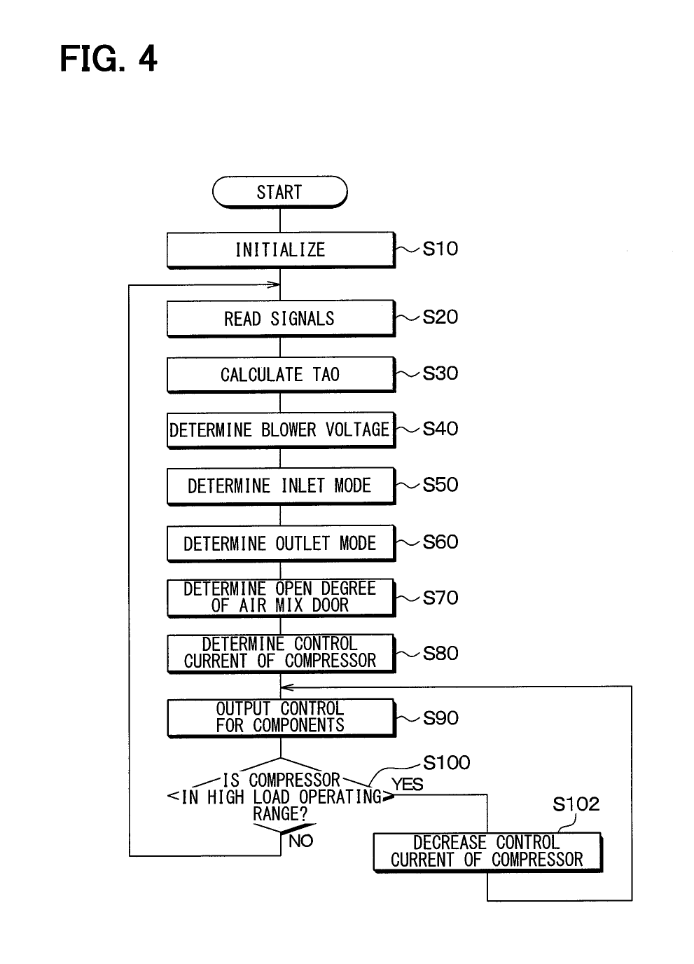

Next, the air-conditioning control processing by the air-conditioner ECU 100 is explained with reference to FIG. 4. FIG. 4 is the flow chart illustrating the air-conditioning control processing by the air-conditioner ECU 100.

First, the air-conditioning switch is turned on, and an auto air-conditioning operation command is inputted into the air-conditioner ECU 100. Then, the air-conditioner ECU 100 starts the air-conditioning control processing according to the air-conditioning control processing shown in FIG. 4. Then, the control program memorized by memory such as ROM and RAM starts, and the data memorized by RAM is initialized at Step S10.

The air-conditioner ECU 100 reads the signals, at Step S20, from the control panel 80, the inside air temperature sensor 81, the outside air temperature sensor 82, the solar radiation sensor 83, the after-evaporator temperature sensor 84, the water temperature sensor 85, the discharge pressure sensor 86, the flow rate sensor 40, the discharge temperature sensor 87, and the engine rotation speed sensor 88.

Next, at Step S30, the target blow-off temperature TAO which is a desired value of temperature of air which blows off into the vehicle cabin is computed by the program (namely, computing equation) memorized by the ROM and the data of the signals. Specifically, the target blow-off temperature TAO is computed using the following expression F2.

TAO=Kset×Tset−Kr×Tr−Kam×Tam−Ks×As+C (F2)

Tset is the target temperature in the vehicle cabin set through the temperature setting switch. Tr is the detection signal detected by the inside air temperature sensor 81. Tam is the detection signal detected by the outside air temperature sensor 82. As is the detection signal detected by the solar radiation sensor 83. Kset, Kr, Kam and Ks are control gains, and C is a constant for compensation.

Then, the air-conditioner ECU 100 determines the voltage for operating the blower 93 which sends air to the vehicle cabin at Step S40. The determination processing of the blower voltage is computed using the characteristics beforehand memorized by ROM.

Next, at Step S50, the air-conditioner ECU 100 determines the inlet mode corresponding to the target blow-off temperature TAO computed at Step S30. The air-conditioner ECU 100 determines the inlet mode using the characteristics beforehand memorized by ROM. For example, when the target blow-off temperature TAO is higher than a predetermined target blow-off temperature, the inside air circulation mode is chosen. When the target blow-off temperature TAO is lower than or equal to a predetermined target blow-off temperature, the outside air introduction mode is chosen.

Next, the air-conditioner ECU 100, at Step S60, determines the outlet mode corresponding to the target blow-off temperature TAO computed at Step S30, based on the characteristics for determining the outlet mode beforehand memorized in ROM or RAM. As the target blow-off temperature TAO is raised, the air-conditioner ECU 100 automatically changes the outlet mode of the air-conditioning zone in order of a face mode, a bilevel mode, and a foot mode. When the face mode is set, an air-conditioning wind blows off only from a face blow-off port. When the foot mode is set, an air-conditioning wind blows off only from a foot blow-off port. When the bilevel mode is set, an air-conditioning wind blows from the face blow-off port and the foot blow-off port.

Next, the air-conditioner ECU 100 computes the target open degree of the air mix door 92 at Step S70. The open degree of the air mix door 92 is calculated by inputting the target blow-off temperature TAO computed at Step S30, the fin temperature after the evaporator detected by the after-evaporator temperature sensor 84, and the cooling water temperature detected by the water temperature sensor 85, into the program (namely, computing equation) memorized by ROM.

Next, at Step S80, the air-conditioner ECU 100 computes the target after-evaporator temperature TEO for realizing the target blow-off temperature TAO determined at Step S30. Specifically, the target after-evaporator temperature TEO is computed so that the temperature of the air blown off into the vehicle cabin approaches the target blow-off temperature TAO. More specifically, the target discharge amount of the compressor 1 is determined using the feedback control (namely, PI control), such that the actual after-evaporator temperature Te which is the detection value of the after-evaporator temperature sensor 84 becomes equal to the target after-evaporator temperature TEO. Further, a control current Ic is determined to satisfy the target discharge amount of the compressor 1. The control current Ic is a current which flows in the coil 53c of the electromagnetic actuator 53, and is equivalent to a capacity control signal which controls the refrigerant discharge capacity of the compressor 1.

Next, the air-conditioner ECU 100 makes the electromagnetic clutch for power intermittence in the connection state at Step S90. Further, the air-conditioner ECU 100 outputs control signals to the actuators M1-M4, to acquire each control state computed or determined at steps S30-S80, and outputs the control current Ic to the flow rate control valve 5 to provide the target discharge amount of the compressor 1.

Next, at Step S100, the air-conditioner ECU 100 determines whether the compressor 1 is in a high load operating range using three conditions, e.g., the control current Ic which flows in the coil 53c of the electromagnetic actuator 53, the rotation speed Nc of the compressor 1, and the temperature Td of the refrigerant discharged from the compressor 1.

The following expression F3 is memorized by the memory of the air-conditioner ECU 100. The air-conditioner ECU 100 presumes the temperature Tc at a predetermined position of the compressor 1 using the expression F3. The air-conditioner ECU 100 determines, at Step S100, whether the compressor 1 is in a high load operating range based on whether the temperature Tc at the predetermined position of the compressor 1 is higher than or equal to a predetermined value.

Tc=f(Ic, Nc, Td) (F3)

Ic represents the control current of the flow rate control valve 5, Nc represents the rotation speed of the compressor 1, and Td represents the temperature of refrigerant discharged from the compressor.

The control current Ic of the flow rate control valve 5 has correlation with the load of the compressor 1, the temperature in the crankcase, and the pressure in the crankcase. That is, when the control current Ic becomes large, the pressure in the crankcase becomes low, the load of the compressor 1 becomes large, and the temperature in the crankcase becomes high. In addition, the current value calculated at Step S90 can be used as the control current Ic of the flow rate control valve 5.

The rotation speed Nc of the driving shaft 23 of the compressor 1 has correlation with heat generation at a shaft seal device such as a mechanical seal, and a slide component such as the radial bearing 24a, 24b and the thrust bearing 241. Since the rotation speed Nc of the driving shaft 23 of the compressor 1 is proportional to the engine speed, the rotation speed Nc can be specified from the output value of the engine rotation speed sensor 88.

The temperature Td of refrigerant discharged from the compressor 1 has correlation with the load of the compressor 1. That is, the load of the compressor 1 becomes large, as the discharge temperature Td of the refrigerant of the compressor 1 becomes high. Moreover, the discharge temperature Td of the refrigerant of the compressor 1 has correlation with the amount of gas refrigerant in the refrigeration cycle. For example, when the amount of gas refrigerant in the refrigeration cycle decreases by aging, the temperature Td of refrigerant discharged from the compressor 1 becomes high. The discharge temperature Td of the refrigerant of the compressor 1 can be specified using the output value of the discharge temperature sensor 87.

The air-conditioner ECU 100 determines whether the compressor 1 is in a high load operating range based on whether the temperature Tc at the predetermined position of the compressor 1 estimated using the expression F3 is higher than or equal to a predetermined value.

When the temperature Tc at the predetermined position of the compressor is less than a predetermined value, it returns to processing of Step S20, and the control processing of Step S20 to Step S100 is repeated. When the temperature Tc at the predetermined position of the compressor 1 presumed using the expression F3 becomes higher than or equal to the predetermined value, it is determined with YES in S100, and the air-conditioner ECU 100 decreases the control current Ic to reduce the refrigerant discharge capacity of the compressor 1. Thereby, the open degree of the flow rate control valve 5 increases, the stroke of the piston 29 decreases, and the discharge capacity of the compressor 1 decreases.

When the temperature Tc at the predetermined position of the compressor 1 presumed using the expression F3 becomes less than a predetermined value, the air-conditioner ECU 100 returns to processing of Step S20, and repeats the control processing of Step S20 to Step S100.

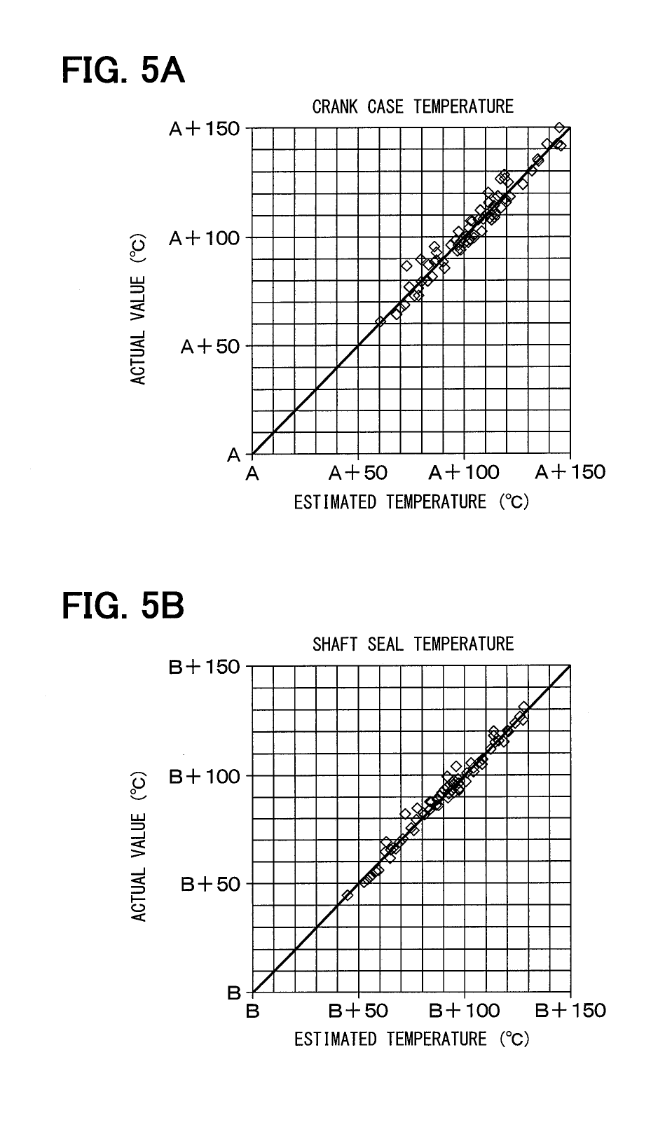

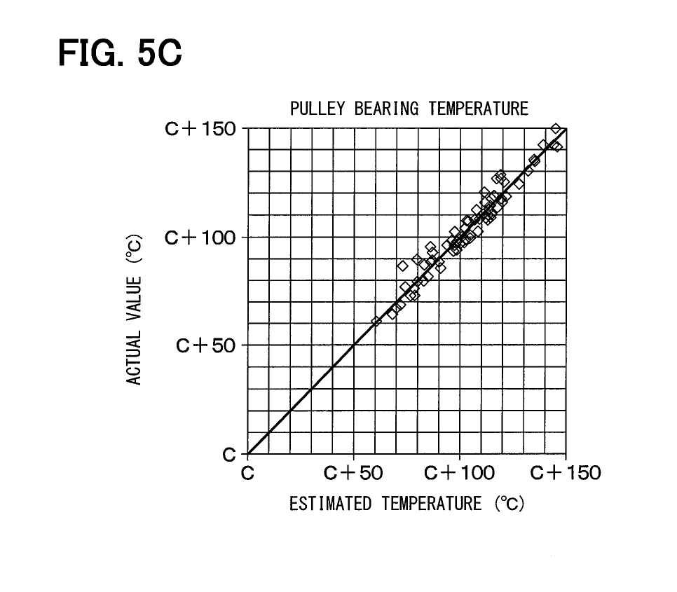

The temperature estimation for each part of the compressor 1 using the expression F3 is explained. FIG. 5A is a graph illustrating a comparative example between the estimated value and the actual measurement value of the crankcase temperature represented by M1 in FIG. 1. FIG. 5B is a graph illustrating a comparative example between the estimated value and the actual measurement value of the shaft seal temperature represented by M2 in FIG. 1. FIG. 5C is a graph illustrating a comparative example between the estimated value and the actual measurement value of the pulley bearing temperature represented by M3 in FIG. 1. As shown in FIG. 5A-FIG. 5C, it is confirmed that the temperature of each part of the compressor can be presumed with sufficient accuracy by using the expression F3.

According to the embodiment, the refrigeration cycle device 60 for a vehicle includes the variable displacement compressor 1, the air-conditioner ECU 100, and the heat exchanger 2. The variable displacement compressor 1 has a discharge capacity varying part which changes the refrigerant discharge capacity. The air-conditioner ECU 100 outputs the capacity control signal to the variable displacement compressor to change the refrigerant discharge capacity. The heat exchanger 2 cools the refrigerant discharged from the variable displacement compressor 1. Furthermore, the refrigeration cycle device 60 includes the expansion valve 3 which decompresses and expands refrigerant which flows out of the heat exchanger 2, the evaporator 4 which evaporates refrigerant decompressed and expanded by the expansion valve 3, and the high load determiner which determines whether the compressor is in a high load operational status based on the capacity control signal. The air-conditioner ECU 100 executes Step S100 so as to correspond to the high load determiner. Accordingly, the high load operational status of the compressor can be determined with sufficient accuracy, without using the discharge pressure of refrigerant.

Moreover, the high load determiner determines whether the compressor is in a high load operational status based on the capacity control signal and at least one of the rotation speed of the variable displacement compressor and the temperature of the refrigerant discharged from the variable displacement compressor. Accordingly, it can be determined with more sufficient accuracy, compared with a case where it is determined based on the capacity control signal whether the compressor is in the high load operational status.

Moreover, carbon dioxide is adopted as a refrigerant. When carbon dioxide is adopted as a refrigerant, it can be determined especially with sufficient accuracy whether the compressor is in the high load operational status.

Moreover, the compressor 1 includes the coil 53c driven by a current, and the flow rate control valve 5. The opening of the flow rate control valve 5 is changed by the control current which drives the coil 53c. The refrigerant discharge capacity can be changed according to the open degree of the flow rate control valve 5.

Moreover, the refrigeration cycle device 60 is applicable to an air-conditioner for a vehicle.

### Second Embodiment

The refrigeration cycle device 60 according to a second embodiment is explained. The refrigeration cycle device 60 of this embodiment is the same as that of the first embodiment. The refrigeration cycle device 60 of this embodiment differs from the first embodiment in processing by the air-conditioner ECU 100.

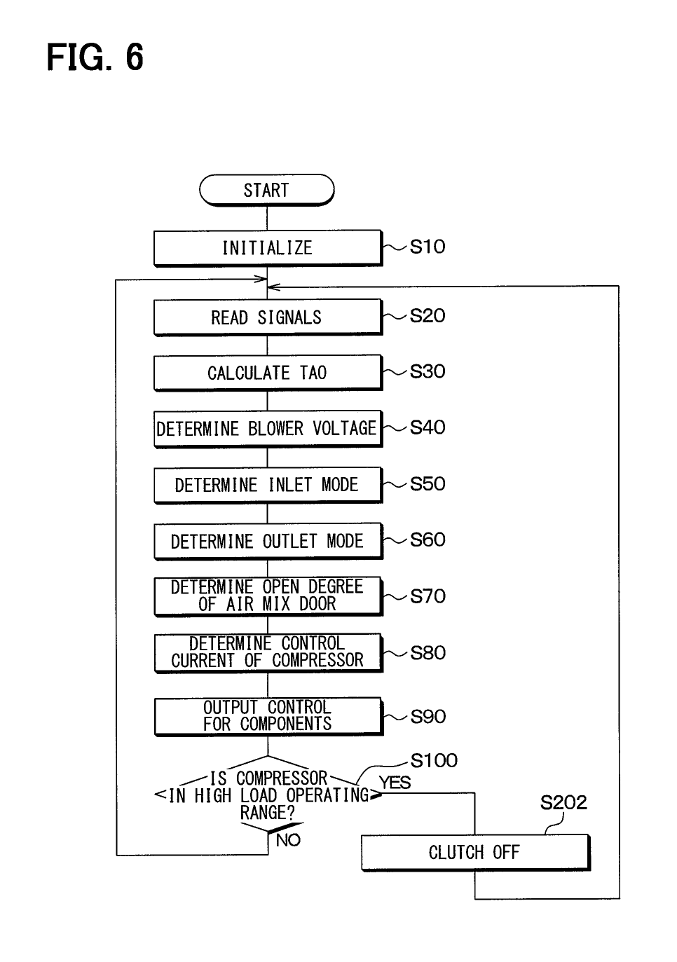

FIG. 6 is the flow chart explaining the air-conditioning control processing by the air-conditioner ECU 100 of this embodiment. Since Step S10 to Step S100 are the same as those of FIG. 4, the explanation is omitted here.

In this embodiment, at Step S100, the air-conditioner ECU 100 determines whether the compressor 1 is in a high load operating range based on whether the temperature Tc at the predetermined position of the compressor 1 presumed using the expression F3 is higher than or equal to a predetermined value.

When the temperature at the predetermined position of the compressor is less than a predetermined value, it returns to processing of Step S20, and the control processing of Step S20 to Step S100 is repeated. When the temperature Tc at the predetermined position of the compressor 1 presumed using the expression F3 becomes higher than or equal to a predetermined value, it is determined with YES in S100. The air-conditioner ECU 100 turns OFF the electromagnetic clutch 38 of the compressor 1 at Step S202, and returns to Step S20. By this, the pulley 380 and the hub 343 are disconnected from each other to stop the transfer of the rotation power from the engine to the compressor 1, and the compressor 1 is in an unloaded condition. Then, it returns to processing of Step S20. When the temperature Tc at the predetermined position of the compressor 1 presumed using the expression F3 becomes higher than or equal to a predetermined value, it returns to Step S20. When the temperature Tc at the predetermined position of the compressor 1 presumed using the expression F3 becomes less than a predetermined value, it returns to processing of Step S20, and repeats the control processing of Step S20 to Step S100.

In this embodiment, the same effect can be acquired as the first embodiment by the common structure as the first embodiment.

### Other embodiment

(1) Carbon dioxide is adopted as a refrigerant in the refrigeration cycle device 60 for a vehicle in the embodiment. Alternatively, refrigerant other than carbon dioxide is also applicable to the refrigeration cycle device 60.

(2) In each of the embodiments, the variable displacement compressor with clutch is explained as an example. The variable displacement compressor may be a clutchless variable displacement compressor such as a DL pulley type compressor.

(3) In each of the embodiments, it is determined whether the compressor 1 is in a high load operating range using the expression F3 in which variables are the control current Ic of the flow rate control valve 5, the rotation speed Nc of the compressor 1, and the discharge temperature Td of the refrigerant from the compressor. Alternatively, it may be determined whether the compressor 1 is in a high load operating range using at least one of the control current Ic of the flow rate control valve 5, the rotation speed Nc of the compressor 1, and the discharge temperature Td of the refrigerant from the compressor.

(4) In each of the embodiments, the temperature Tc at the predetermined position of the compressor 1 is presumed using the expression F3, and it is determined whether the compressor 1 is in a high load operating range based on whether the temperature Tc at the predetermined position of the compressor 1 is beyond a predetermined value. However, it is not necessary to presume the temperature Tc of the predetermined position of the compressor 1. It may be determined whether the compressor 1 is in a high load operating range using a function in which variables are the control current Ic of the flow rate control valve 5, the rotation speed Nc of the compressor 1, and the discharge temperature Td of the refrigerant from the compressor.

(5) In each of the embodiments, the control current which flows in the coil 53c of the flow rate control valve 5 is defined as the capacity control signal which controls the refrigerant discharge capacity of the compressor 1. However, the capacity control signal may be a signal from a slanting board angle detection sensor or a crankcase internal pressure sensor, which can presume the capacity, other than the control current which flows in the coil 53c of the flow rate control valve 5.

It should be appreciated that the present disclosure is not limited to the embodiments described above and can be modified appropriately. The embodiments above are not irrelevant to one another and can be combined appropriately unless a combination is obviously impossible. In the respective embodiments above, it goes without saying that elements forming the embodiments are not necessarily essential unless specified as being essential or deemed as being apparently essential in principle. In a case where a reference is made to the components of the respective embodiments as to numerical values, such as the number, values, amounts, and ranges, the components are not limited to the numerical values unless specified as being essential or deemed as being apparently essential in principle. Also, in a case where a reference is made to the components of the respective embodiments above as to shapes and positional relations, the components are not limited to the shapes and the positional relations unless explicitly specified or limited to particular shapes and positional relations in principle.

### Conclusion

According to the first viewpoint shown by a part or all of the embodiment, the refrigeration cycle device for a vehicle includes: a variable displacement compressor including a discharge capacity varying part to change a refrigerant discharge capacity; a controller that outputs a capacity control signal to the variable displacement compressor to change the refrigerant discharge capacity; a heat exchanger that condenses or cools refrigerant discharged from the variable displacement compressor; a decompressor that decompresses and expands refrigerant flowing out of the heat exchanger; an evaporator that evaporates refrigerant decompressed and expanded by the decompressor; and a high load determiner that determines whether the compressor is in a high load operational status based on the capacity control signal.

According to the second viewpoint, the high load determiner determines whether the compressor is in a high load operational status based on the capacity control signal and at least one of a rotation speed of the variable displacement compressor and a temperature of the refrigerant discharged from the variable displacement compressor. Accordingly, as compared with a case where it is determined based on a capacity control signal whether a compressor is in a high load operational status, it can be determined with more sufficient accuracy.

According to the third viewpoint, the high load determiner determines whether the compressor is in a high load operational status based on the capacity control signal, a rotation speed of the variable displacement compressor, and a temperature of the refrigerant discharged from the variable displacement compressor. Accordingly, as compared with the case where it is determined based on a capacity control signal whether a compressor is in the high load operational status, it can be determined more sufficient accuracy.

According to the 4th viewpoint, carbon dioxide is adopted as a refrigerant. Thus, when carbon dioxide is adopted as a refrigerant, it can be determined especially with sufficient accuracy whether the compressor is in the high load operational status.

According to the 5th viewpoint, the compressor includes a coil driven with a current, and a flow rate control valve with an opening changed by a control current that drives the coil, the refrigerant discharge capacity being changed in accordance with the opening of the flow rate control valve.

According to the 6th viewpoint, the refrigeration cycle device is applied to an air-conditioner for a vehicle.

What is claimed is:

1. A refrigeration cycle device comprising:
a variable displacement compressor including a discharge capacity varying part to change a refrigerant discharge capacity;
a controller that outputs a capacity control signal to the variable displacement compressor to change the refrigerant discharge capacity;
a heat exchanger that condenses or cools refrigerant discharged from the variable displacement compressor;
a decompressor that decompresses and expands refrigerant flowing out of the heat exchanger;
an evaporator that evaporates refrigerant decompressed and expanded by the decompressor; and
a high load determiner that estimates a temperature at a predetermined position of the variable displacement compressor based on the capacity control signal, wherein the high load determiner determines whether the compressor is in a high load operational status based on the estimated temperature.

2. The refrigeration cycle device according to claim 1, wherein
the high load determiner determines whether the compressor is in a high load operational status based on the capacity control signal and at least one of a rotation speed of the variable displacement compressor and a temperature of refrigerant discharged from the variable displacement compressor.

3. The refrigeration cycle device according to claim 1, wherein
the high load determiner determines whether the compressor is in a high load operational status based on the capacity control signal, a rotation speed of the variable displacement compressor, and a temperature of refrigerant discharged from the variable displacement compressor.

4. The refrigeration cycle device according to claim 1, wherein the refrigerant is a carbon dioxide.

5. The refrigeration cycle device according to claim 1, wherein
the compressor includes a coil driven by a current, and a flow rate control valve having an opening changed by a control current that drives the coil, the refrigerant discharge capacity being changed in accordance with the opening of the flow rate control valve, and
the capacity control signal is the control current.

6. The refrigeration cycle device according to claim 1, that is applied to an air-conditioner for a vehicle.

7. The refrigeration cycle device according to claim 1, wherein a clutch that transmits power to a driving shaft of the variable displacement compressor is turned off when the high load determiner determines that the compressor is in the high load operational status.

8. The refrigeration cycle device according to claim 5, wherein
the variable displacement compressor has a slanting board that rotates,
the slanting board rotates to discharge refrigerant introduced in an intake chamber to a discharge chamber through a compression chamber,
the flow rate control valve has
a valve object that adjusts an open degree of an air supply passage through which the discharge chamber communicates with a crankcase communicated with the intake chamber, and
an electromagnetic actuator connected with the valve object.
